(19) United States
(12) Patent Application Publication
(10) Pub. No.: US 2026/0031072 A1
(43) Pub. Date: Jan. 29, 2026

(54) CONFIGURABLE NON-CONTACT MUSICAL INSTRUMENT ENHANCEMENT SYSTEM

(71) Applicant: Jorge Marticorena, Lake Worth Beach, FL (US)

(72) Inventor: Jorge Marticorena, Lake Worth Beach, FL (US)

(21) Appl. No.: 19/335,190

(22) Filed: Sep. 22, 2025

Related U.S. Application Data
(63) Continuation-in-part of application No. 17/681,779, filed on Feb. 27, 2022, now abandoned.

(51) Int. Cl. G10H 1/34; G10H 1/00

(52) U.S. Cl. CPC G10H 1/34; G10H 1/0008; G10H 2220/026; G10H 2220/201; G10H 2220/461

(57) ABSTRACT

A modular musical control system is provided. The modular musical control system comprises one or more sensor modules detachably attached over a musical instrument, wherein each of the one or more sensor modules are configured to detect one or more hand gestures of a user within a sensing region; and generate one or more signals indicative of the detected one or more hand gestures; a control hub. The control hub comprises a memory, and at least one processor. The at least one processor is configured to receive the one or more signals; determine one or more control parameters corresponding to at least one of proximity, velocity, gesture-based, or touch-based interaction; generate, in real time, at least one control output signal comprising at least one of analog or digital musical data; and transmit the at least one control output signal to an audio processing device to generate an audio output.

### CROSS-REFERENCE TO RELATED APPLICATIONS

This application claims priority to the utility non-provisional application having an application number file Ser. No. 17/681,779 filed on Feb. 27, 2022, and application Ser. No. 16/517,603 filed on Jul. 21, 2019, and provisional application No. 62/701,789 filed on Jul. 22, 2018, and are incorporated herein by reference in its entirety.

### FIELD OF THE INVENTION

The present invention relates generally to musical instruments, and more particularly, to a configurable non-contact musical instrument enhancement system, which utilize sensor pods to communicate with other audio technologies to produce integrated musical sound.

### BACKGROUND OF THE INVENTION

Conventional musical control interfaces, such as foot-operated expression pedals, foot-operated switches, push buttons, faders, keys, drum pads, wheels, joysticks, and rotary dials, are inherently limited by their physical design and mechanical constraints. For example, an expression pedal is physically structured to provide a variable control range, typically from 0% to 100%, for modulation effects, while a push button or drum pad is generally configured for binary on/off actuation. In some cases, synthesizers or MIDI controllers may include dials that also function as buttons, allowing multiple modes of operation; however, such arrangements can be cumbersome to operate, particularly in dynamic performance environments. All of these physical interfaces are constrained by their specific form factors and the mechanical nature of their operation, which can limit flexibility, accessibility, and the range of expressive control available to a performer.

Many methods and systems have been used unsuccessfully attempting to incorporate modes of generating unique musical sounds produced solely by a musician's movements within the proximity of a musical instrument or control surface the musician is performing on. Several devices and methods have been created attempting unsuccessfully to solve the problem of producing integrated musical sounds without direct physical contact with a musical interface comprising musical instruments, musical software, music hardware, controllers etc., in a practical way. These previous systems and methods have not been effective in solving the problem of overcoming the limitations of a musician's interaction to produce integrated musical sounds solely by physical touch. Further, these previous systems and methods have not been effective in taking advantage of digital audio technology to augment interaction between a musician and an instrument, device and/or software beyond the limitations of physical touch to control and/or produce integrated musical sounds.

There have been many unsuccessful attempts by musicians to digitally generate musical sounds other than by pushing buttons, pressing keys, striking pads, or turning dials. For musicians, playing live music is about moving the body and being physical. Current musical instruments and device hardware continue to limit the ways in which a musician can use digital controls to bridge the gap between their physical movements and the sounds that those movements can generate and/or manipulate during a performance.

Accordingly, there is an established need for integrated musical instrument systems which solve at least one of the aforementioned problems. Further, there is an established need for integrated musical instrument systems which can combine various sounds generated by movement without the necessity of physical touch.

### SUMMARY OF THE INVENTION

The present invention is directed to configurable non-contact musical instrument enhancement system i.e., a modular musical control system. The modular musical control system can be interchangeably termed as systems. These systems are used to produce integrated musical sounds that are controlled by a musician's hands, head, feet, hands, fingers, torso, appendages, and/or objects as the musician physically interacts with devices. These systems incorporate the musical sounds resulting from movement and/or presence of physical objects in the proximity of the devices. These devices provide unique methods of playing sounds which can be programmed and varied, and wherein sound can be manifested and controlled directly and in real-time from digital and/or analog audio software and/or hardware, or concurrently with sounds generated by a musical instrument the musician is playing by reacting to the physical movements manifested while in the act of playing. These devices can also directly manipulate the sound generated by a musical instrument the musician is playing.

According to an aspect of the present disclosure, a modular musical control system is disclosed. The modular musical control system comprises one or more sensor modules detachably attached over a musical instrument, each of the one or more sensor modules are configured to detect one or more hand gestures of a user within a sensing region; and generate one or more signals indicative of the detected one or more hand gestures. Further, the modular musical control system comprises a control hub communicatively coupled to each of the one or more sensor modules. Further the control hub comprises a memory having one or more computer readable instructions and at least one processor communicatively coupled to the memory. Further, the at least one processor executing the one or more computer readable instructions stored in the memory is configured to: receive the one or more signals from each of the one or more sensor modules; determine one or more control parameters corresponding to at least one of proximity, velocity, gesture-based, or touch-based interaction, based at least on the received one or more signals; generate, in real time, at least one control output signal comprising at least one of analog or digital musical data, based at least on the one or more control parameters; and transmit the at least one control output signal to an audio processing device to generate an audio output.

Further, each of the one or more sensor modules comprises at least a short-range proximity sensor, a long-range proximity sensor, optical proximity sensors, and infrared proximity sensors.

Further, each of the one or more sensor modules and the control hub further comprises at least one of a wired or wireless communication interface configured to enable bidirectional communication between the one or more sensor modules and the control hub.

Further, the wherein the one or more control parameters comprise a value derived from received one or more signals indicative of at least one of a proximity between hand of the user and the one or more sensor modules, a velocity of the hand gestures relative to the one or more sensor module, or type of the hand gestures performed by the hand.

Further, each of the one or more sensor modules are removably attached over the musical instrument using one or more fasteners comprising at least one of an adhesive fastener, a magnetic fastener, or a mechanical fastener.

Further, the audio processing device comprises corresponds to an audio processing device of the musical instrument, software instrument, device firmware, user interface, a digital audio workstation (DAW), or a MIDI-enabled device to control the device's parameters and audio output during a performance. Further, the audio processing device comprises the analog or digital musical data comprises at least one of musical instrument digital interface (MIDI) data that is configured to control and modulate musical notes, sounds, effects, and parameters.

Further, the control hub may correspond to a foot-operated control hub or musical instrument mounted control hub, wherein the control hub further comprises additional buttons, dials, and at least one switch configured to selectively enable or disable each of the one or more sensor modules or change system settings.

Further, each of the one or more sensor modules further comprises one or more light indicators, the one or more light indicators are configured to turn into one or more colors when the at least one switch is configured to selectively enable or disable corresponding sensor module of the one or more sensor modules.

Further, each of the one or more sensor modules are configured to be repositionable to one or more locations over the musical instrument to enable customized placement for a plurality of playing techniques or musical styles.

Further, each of the one or more sensor modules are configured to provide combined control modes, including gradual control based on proximity, velocity-sensitive control based on striking or swiping motions, binary triggering based on touch-based percussive interaction and the 3-dimensional gesture interaction.

According to an aspect of the present disclosure, a method is disclosed. The method comprises steps of receiving, via at least one processor communicatively coupled to a memory of a control hub, wherein the at least one processor executing the one or more computer readable instructions stored in the memory of the control hub communicatively coupled to each of one or more sensor modules, one or more signals from each of the one or more sensor modules detachably attached over a musical instrument, each of the one or more sensor modules are configured to: detect one or more hand gestures of a user within a sensing region; and generate one or more signals indicative of the detected one or more hand gestures; determining, via the at least one processor, one or more control parameters corresponding to at least one of proximity, velocity, gesture-based, or touch-based interaction, based at least on the received one or more signals; generating, in real time, via the at least one processor, at least one control output signal comprising at least one of analog or digital musical data, based at least on the one or more control parameters; and transmitting, via the at least one processor, the at least one control output signal to an audio processing device to generate an audio output based at least on the audio output parameter.

These and other objects, features, and advantages of the present invention will become more apparent from the attached drawings and the detailed description of the preferred embodiments, which follow. It is understood that the drawings are designed for the purposes of illustration and not as a definition of the limits of the embodiments of the present invention. It should be further understood that the drawings are not necessarily drawn to scale and are merely intended to conceptually illustrate the methods and systems described herein.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 illustrates a block diagram of a modular musical control system, according to an embodiment of the present invention;

FIG. 2 illustrates a top view of a musical instrument attached with one or more sensor modules, according to an embodiment of the present invention;

FIG. 3 illustrates a perspective view of the musical instrument attached with the one or more sensor modules, according to an embodiment of the present invention;

FIG. 4 illustrates an exemplary scenario of the user performing one or more hand gestures, according to an embodiment of the present invention.

FIG. 5A illustrates the hand of the user outside a three-dimensional sensing region of the sensor module-1, according to an embodiment of the present invention.

FIG. 5B illustrates the hand of the user within a three-dimensional sensing region of the sensor module-1, according to an embodiment of the present invention

FIG. 6 illustrates a perspective view of the control hub, according to an embodiment of the present invention.

FIG. 7 illustrates a front view of the control hub, according to an embodiment of the present invention.

Referring to FIG. 8 illustrates a flow chart of a method associated with the modular musical control system, according to an embodiment of the present invention.

Like reference numerals refer to like parts throughout the several views of the drawings.

### DETAILED DESCRIPTION

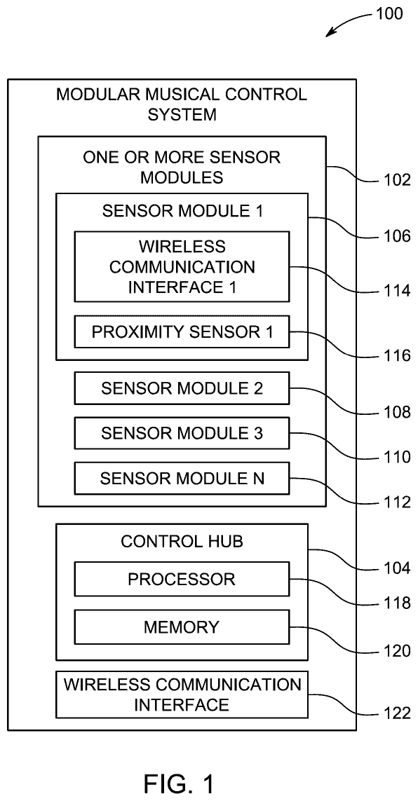

The following detailed description is exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, embodiments of the present invention are directed towards methods and systems for integrating musical instruments and/or software with devices and sensors. These devices and sensors can function in concert and configured as an integrated musical instrument system.

FIG. 1 illustrates a block diagram of a modular musical control system 100, in accordance with an embodiment of the present invention.

In some embodiments, the modular musical control system 100 comprises one or more sensor modules 102 and a control hub 104. In some embodiments, the one or more sensor modules 102 comprises a sensor module-1 106, a sensor module-2 108, a sensor module-3 110, and sensor module-N 112. Further, the sensor module-1 106, the sensor module-2 108, the sensor module-3 110, and the sensor module-N 112 may be detachably attached at one or more locations of the musical instrument. In some embodiments, the sensor module-1 106, sensor module-2 108, sensor module-3 110 and sensor module-N 112, may be detachably attached at one or more locations of a fixed surface (e.g. a table top). Further, the sensor module-1 106 comprises at least one of a wired or wireless communication interface-1 114, and a proximity sensor-1 116. It may be noted that, similar to the sensor module-1 106, the sensor module-2 108, the second module-3 110, and the second module-N 112 may have corresponding at least any of wired or wireless communication interface and proximity sensor.

In some embodiments, each of the one or more sensor modules 102 may be configured to detect one or more hand gestures of a user within a sensing region using the proximity sensors. In some embodiments, the sensing region may correspond to a three-dimensional space extending outward from the one or more sensor modules 102 in which variations in proximity, movement velocity, and spatial position of the user's hand may be accurately captured. Detection of the hand gestures may be achieved using at least one proximity sensor, optical sensor, or motion detection sensor integrated within the sensor modules 102, enabling recognition of gestures such as waving, swiping, or hovering.

Further, the one or more sensor modules 102 is configured to generate one or more signals indicative of the detected one or more hand gestures. Upon detecting the one or more hand gestures, the one or more sensor modules 102 may be configured to generate the one or more signals indicative of the detected gestures. These one or more signals may include raw sensor data, such as distance measurements, velocity vectors, or gesture classification codes, and may be formatted as analog or digital output. The generated one or more signals are representative of the dynamic characteristics of the detected hand gestures and are transmitted, either directly or via an intermediate processing unit, to the control hub 104 for further interpretation and mapping to corresponding control parameters.

Further, the control hub 104 comprises a memory 120, at least one processor 118, and at least one from among wired or wireless communication interface 122. In some embodiments, the control hub 104 may be communicatively coupled to each of the one or more sensor modules 102 via the at least one from wired or wireless communication interface 122 and corresponding the at least one from wired or wireless communication interface 122 of each of the one or more sensor modules 102. In some embodiments, the at least one processor 118 is configured to receive the one or more signals from each of the one or more sensor modules 102.

Further, the at least one processor 118 is configured to determine one or more control parameters corresponding to at least one of proximity, velocity, gesture-based interaction or touch-based interaction, based at least on the received one or more signals. In some embodiments, determining the one or more control parameters may involve analyzing the temporal and spatial variations in the received signals to extract measurable attributes, such as the distance of the user's hand from the one or more sensor modules s, the variations in that distance to derive movement, the rate of change in that distance to derive velocity, and the recognition of specific gesture patterns through predefined algorithms or machine learning models. The at least one processor 118 may apply filtering techniques to reduce noise, normalize signal values, and enhance accuracy, thereby ensuring that the calculated control parameters accurately represent the user's intended input for subsequent mapping to an audio output parameter.

Further, the at least one processor 118 may be configured to generate, in real time, at least one control output signal based at least on the one or more control parameters. In some embodiments, the at least one processor 118 may convert parameter into a corresponding electrical or digital signal format suitable for transmission to an audio processing device of the musical instrument. The generation of the control output signal may be performed with minimal latency to preserve the timing and responsiveness required for live musical performance, ensuring that variations in proximity, velocity, or gesture-based interaction are reflected immediately in the resulting sound. The control output signal may include continuous control data for gradual effects or discrete control data for triggering specific audio events, depending on the mapped parameter and the intended audio response.

Further, the audio output parameter comprises at least one audio effect, musical modulation, or musical instrument digital interface (MIDI) control value. In some embodiments, the mapping process may be carried out by referencing a predefined mapping table or configuration data stored in the memory 120, wherein each control parameter or combination thereof corresponds to a specific audio effect (e.g., reverb, delay, distortion), a musical modulation (e.g., pitch bend, vibrato, tremolo), or a MIDI control value in accordance with the MIDI standard. The processor 118 may perform this mapping dynamically in real time, enabling smooth and continuous variation of the output based on user gestures, proximity, or velocity, thereby providing an expressive and intuitive control interface for the musical instrument.

Further, the at least one processor 118 may be configured to transmit the at least one control output signal to the audio processing device to generate an audio output based at least on the audio output parameter, The transmitted control output signal may be received by the audio processing device, which may include software instrument, device firmware, user interface, a digital audio workstation (DAW), or a MIDI-enabled device to control the device's parameters and audio output during a performance. Upon receipt, the audio processing device may process the control output signal in accordance with the mapped audio output parameter to produce the desired audio output, such as applying an effect, modulating a tone, triggering a sound sample, or adjusting playback characteristics in real time.

Further, each of the one or more sensor modules 102 may be removably attached over the musical instrument or the fixed surface of the tabletop. Further, the each of the one or more sensor modules 102 may be removably attached using one or more fasteners comprising at least one of an adhesive fastener, a magnetic fastener, or a mechanical fastener. In some embodiments, the adhesive fastener may include reusable, non-permanent bonding materials such as double-sided adhesive pads or hook-and-loop strips, allowing repeated attachment and removal without damaging the surface of the musical instrument. The magnetic fastener may utilize embedded magnets within the housing of the one or more sensor modules 102 and corresponding ferromagnetic or magnetic components affixed to the musical instrument, enabling secure yet easily detachable mounting. The mechanical fastener may include clamps, brackets, or screw-based fixtures configured to hold the one or more sensor modules 102 firmly in place during performance while permitting straightforward removal for repositioning, maintenance, or storage. Such removable attachment mechanisms allow musicians to flexibly position the one or more sensor modules 102 at desired locations on different types or sizes of musical instruments to suit playing style, ergonomics, or specific performance requirements.

In another embodiment, each of the one or more sensor modules 102 may be configured to magnetically connect to the control hub 104. The magnetic connection may be achieved using one or more alignment magnets embedded within the housing of the one or more sensor modules 102 and corresponding magnets or ferromagnetic elements integrated into the control hub 104. The magnetic interface not only provides a secure mechanical coupling but also aligns electrical contact points or inductive charging coils between the one or more sensor modules 102 and the control hub 104. Once magnetically connected, the control hub 104 may be configured to charge the one or more sensor modules 102 using a wired power transfer through conductive contact pads, or wirelessly via inductive charging. This arrangement allows the one or more sensor modules 102 to be recharged conveniently without requiring separate charging cables or ports, thereby reducing setup complexity and ensuring that the one or more sensor modules 102 remain powered and ready for operation during extended use.

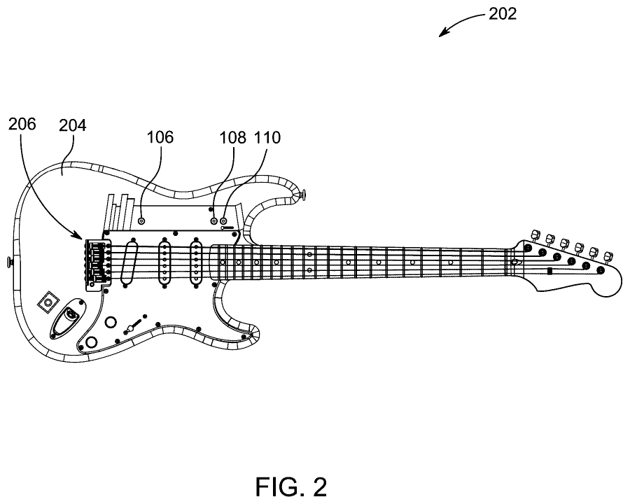

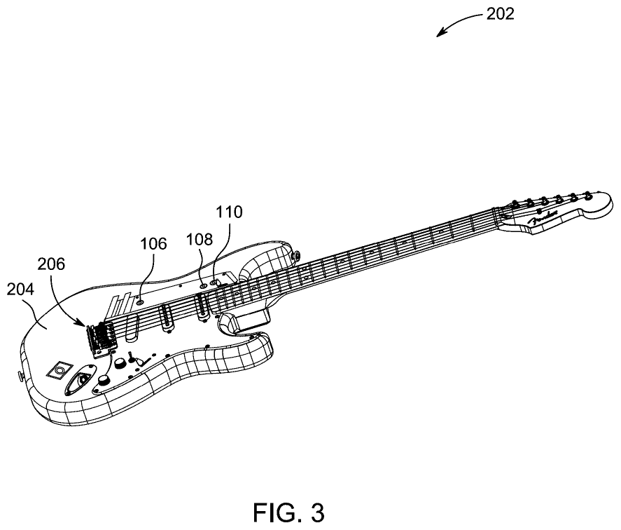

FIG. 2 illustrates a top view of a musical instrument 202 attached with the one or more sensor modules 102, according to an embodiment of the present invention. FIG. 3 illustrates a perspective view of the musical instrument 202 attached with the one or more sensor modules 102, according to an embodiment of the present invention.

In one example embodiment, the musical instrument 202 may correspond to a guitar. The musical instrument 202 may be attached with the one or more sensor modules 102. In some embodiments, the one or more sensor modules 102 comprises the sensor module-1 106, the sensor module-2 108, the sensor module-3 110, and the sensor module-N 112. Further, the sensor module-1 106, the sensor module-2 108, the sensor module-3 110, and the sensor module-N 112 may be detachably attached at one or more locations of the musical instrument. In some embodiments, the sensor module-1 106, sensor module-2 108, sensor module-3 110 and sensor module-N 112, may be detachably attached at one or more locations of a fixed surface (e.g. a table top). Further, the sensor module-1 106 comprises at least one of a wired or wireless communication interface-1 114, and a proximity sensor-1 116. The one or more sensor modules 102 may function as a binary (on/off) sensor, with a plurality of responses and/or parameters upon activation.

In some embodiments, the musical instrument 202 comprises a body portion 204 supporting strings stretched along a neck portion. As shown, one or more sensor modules 106, 108, 110 are detachably attached over a surface of the body portion 204 of the musical instrument 202. Each sensor module is positioned in proximity to a string region and the strumming/picking area such that hand gestures of a user performed during normal playing positions fall within a corresponding sensing region of each module. For example, sensor module 106 may be disposed adjacent to the bridge section 206 to detect picking hand gestures, while sensor module 108 may be positioned centrally along the body to detect mid-air gestures or swiping motions, and sensor module 110 may be positioned closer to the neck joint to detect additional gestural inputs.

As illustrated in FIG. 3, which depicts the perspective view of the musical instrument 202 with the one or more sensor modules 102 attached, the modular arrangement allows the sensor modules 106, 108, 110 to be repositioned or removed from the surface of the musical instrument 202. This provides a high degree of customization, enabling the performer to mount the modules at preferred locations suitable for different playing techniques or musical styles. Each sensor module defines a respective sensing region extending outward from the surface of the instrument 202, wherein hand gestures such as proximity movements, swipes, taps, or velocity-based interactions are detected and translated into control signals.

In some embodiments, the one or more sensor modules 102 are removably attached to the musical instrument 202 using one or more fasteners. In one example, the one or more sensors modules 102 may include an adhesive fastener such as a reusable polymer pad or double-sided tape that allows temporary mounting on the instrument surface without damaging the finish. In another example, the one or more modules 102 may employ a magnetic fastener configured to couple the one or more sensor modules 102 to the musical instrument 202, particularly suitable where body of the musical instrument 202 includes ferromagnetic material or a thin magnetic plate adhered beneath the surface finish. In yet another embodiment, a mechanical fastener may be utilized, including but not limited to clips, brackets, or slide-in rails, which mechanically engage with an edge, cavity, or designated mounting point of the musical instrument 202.

The one or more sensor modules 102 may be removable to provide multiple advantages to the user such as the user may detach the one or more modules 102 when not in use, reposition the one or more modules 102 at alternate locations over the instrument for experimental control schemes, or replace/upgrade modules without modifying the underlying instrument. This modularity ensures compatibility across a variety of stringed instruments, such as guitars, bass guitars, or similar instruments, while maintaining the integrity and original structure of the musical instrument 202.

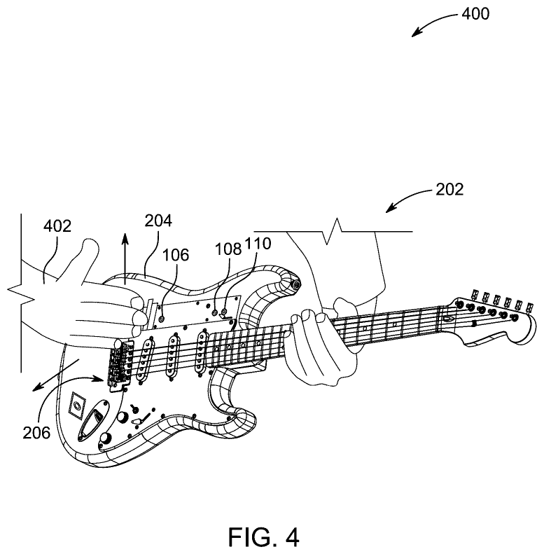

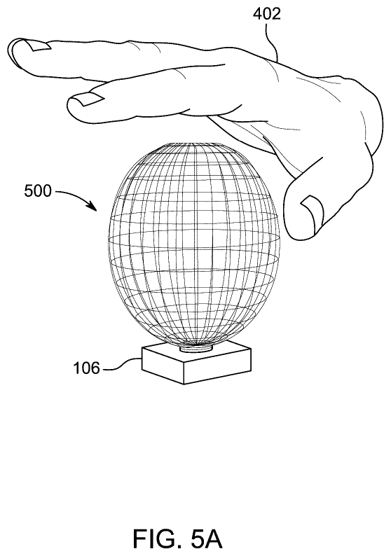

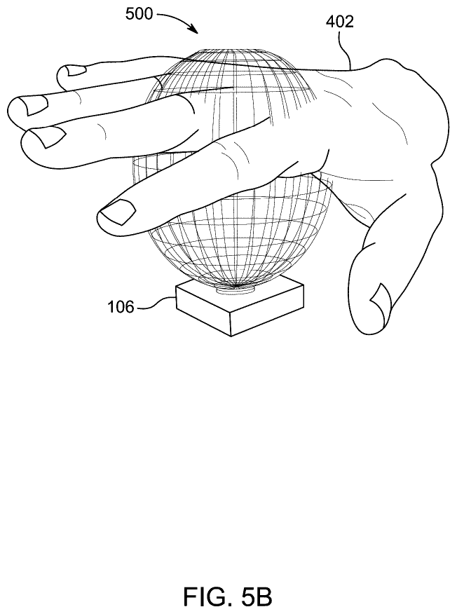

FIG. 4 illustrates an exemplary scenario 400 of the user performing one or more hand gestures, according to an embodiment of the present invention. FIG. 5A illustrates the hand of the user outside a three-dimensional sensing region of the sensor module-1 106, according to an embodiment of the present invention. FIG. 5B illustrates the hand of the user within a three-dimensional sensing region of the sensor module-1 106, according to an embodiment of the present invention

As shown in FIG. 4, a hand 402 of the user is shown in a typical playing posture, with one hand positioned in proximity to the one or more sensor modules 102 for strumming or gestural control, and another hand positioned along the fretboard of the musical instrument 202. In this configuration, the sensing regions of the one or more sensor modules extend outwardly from the surface of the musical instrument 202, allowing hand movements and gestures to be detected during normal performance.

In some embodiments, during a runtime, when the system 100 is powered on and initialized, each sensor module 106, 108, 110 begins generating raw proximity data. In the present embodiment, the sensors include infrared proximity sensors configured to detect distance variations of a user's hand relative to the surface of the instrument. The raw sensor output values correspond to analog or digital numerical readings that vary in accordance with the distance of the hand. For example, as the user's hand 402 approaches within a threshold distance of approximately four inches, the one or more sensor modules 102 generates readable values that progressively increase as the hand 402 moves closer, and decrease as the hand moves away.

In some embodiments, the raw sensor data is transmitted, via wired or wireless communication interfaces, to a control hub 104. The control hub 104 comprises the at least one processor 118 communicatively coupled to the memory 120 storing computer-readable instructions. Upon execution, the at least one processor 118 is configured to receive the raw proximity values and rescale them into a standardized range of 0-127. This range is selected to align with the MIDI communication protocol and represents a normalized control scale from 0% to 100%. For instance, the hand 402 just crossing the sensor threshold generates a scaled value of 1, while a hand in direct contact with the sensor surface generates a scaled value of 127.

Once rescaled, the at least one processor 118 determines one or more control parameters from the incoming data. In the illustrated example of FIG. 4, the at least one processor 118 evaluates control parameters associated with proximity-based interaction and velocity-based interaction. The proximity parameter is derived directly from the distance-based rescaled value (0-127). In certain embodiments, velocity parameters may be calculated based on the rate of change of consecutive rescaled values; for example, a rapid change from 0 to 127 may be interpreted as a high-velocity gesture, while a gradual change may correspond to a low-velocity gesture.

In some embodiments, the at least one processor 118 next generates at least one control output signal in real time based on the determined control parameters. In one embodiment, the output signal corresponds to a MIDI Control Change (CC) message. The CC message comprises three fields: a control number, a control value, and a channel number. The control value corresponds directly to the rescaled sensor value (0-127), allowing the user's hand movement to be mapped continuously to a musical parameter such as volume, panning, filter cutoff, or modulation depth. The control number is user-configurable and determines the assignment of the CC message to a specific musical effect. The channel number specifies which of the sixteen available MIDI channels the message is transmitted through, enabling concurrent control of multiple MIDI-enabled devices.

In another embodiment, the at least one processor 118 is further configured to generate MIDI Note On and Note Off messages, thereby enabling binary or discrete triggering of musical notes and sounds. When the hand 402 crosses the sensor threshold (value>0), the at least one processor 118 issues a Note On message with a designated note number (e.g., middle C, note #60). The message may also include a velocity value corresponding to the detected gesture speed, thereby controlling the loudness of the triggered note. When the hand 404 exits the sensing region and the rescaled value returns to 0, the at least one processor 118 issues a Note Off message, terminating the note. In alternate configurations, the processor may be programmed to send distinct notes based on sensor depth—e.g., triggering one note when crossing the threshold and a different note when in direct contact with the sensor.

The modular musical control system 100 is further capable of outputting other categories of MIDI messages, such as pitch bend, aftertouch, program change, and timing/clock synchronization messages, as determined by the user settings stored in memory. These modes are configurable via the control hub 104, which may comprise foot-operated switches, dials, or software-based editors accessible through external computing devices. Further, the generated control output signal is transmitted from the control hub 104 to one or more audio processing devices. These may include hardware such as synthesizers, sequencers, or guitar pedals, or software such as digital audio workstations and virtual instruments. Communication may occur via bidirectional wired protocols (USB, MIDI cable, CV/Gate) or wireless protocols (Bluetooth).

Further, as shown in FIG. 5A and 5B, an exemplary gestural interaction is illustrated. The FIG. 5A shows a user's hand 402 outside a three-dimensional sensing region 500 surrounding the second module-1 106. Further, FIG. 5B shows a user's hand 402 within the three-dimensional sensing region 500 surrounding the second module-1 106. The spherical wireframe is depicted for illustrative purposes to demonstrate how proximity and orientation of a user's hand relative to a sensor module is captured. As the hand 402 approaches the spherical region, raw proximity values are generated and transmitted to the at least one processor 118. Within the sensing region 500, lateral swipes, vertical movements, and hovering gestures may be distinguished by analyzing the variation and velocity of the rescaled 0-127 values.

In one embodiment, the at least one processor 118 maps gradual proximity changes to CC messages (continuous modulation), rapid swipes to high-velocity Note On messages, and simple threshold crossings to binary Note On/Off messages. This multi-modal control architecture allows a performer to combine expressive continuous modulation with discrete note triggering, using the same sensor module. FIG. 5 thus demonstrates how the modular musical control system 100 enables three core categories of MIDI-based interaction: (i) gradual continuous control, (ii) binary triggering, and (iii) velocity-sensitive triggering.

In one example embodiment, a musician sets up the modular musical control system 100 in their studio. The musical device 202 is plugged in and powered on. The infrared proximity sensor of the one or more sensors modules 102 begins running and generating raw distance values. The musician waves his hand 402 slowly above the one or more sensors modules 102. At first, their hand is just inside the sensor's readable threshold, about 4 inches away. The one or more sensor modules 102 outputs a small raw number, which the at least one processor 118 instantly rescales to a MIDI value of 1 (just above 0%). As the hand moves closer, the raw numbers increase and the processor continues mapping them to values between 1-127. By the time the musician's hand is nearly touching the sensor, the processor sends a MIDI value of 127 (full 100%).

Further, this data is transmitted as a Control Change (CC) message. The musician has mapped CC #3 on channel 8 to the volume parameter of a connected MIDI guitar pedal. As the hand 402 moves up and down above the one or more sensors modules 102, the volume rises and falls in real time, just like turning a knob on the pedal but without touching anything. Further, the musician switches the modular musical control system 100 to Note On/Note Off mode. The musician moves the hand 402 across the threshold again. As soon as the one or more sensor modules 102 detects a value greater than zero, the at least one processor 118 sends a Note On message for middle C (MIDI note #60) with velocity 127. The synthesizer plays the note. The musician holds the hand 402 within the one or more sensor's range, and the note continues to play. When the musician moves the hand 402 out of range and the sensor value drops to 0, the at least one processor 118 sends a Note Off message, and the sound stops.

The quick swipe registers as a loud note (velocity closer to 127), while a slow, gentle movement produces a softer note (velocity closer to 20-40). This mimics the expressive dynamics of a piano. The musician then experiments with a hybrid setup: when the hand 402 first crosses the threshold, it triggers a Note On message (playing a drum hit), and as the musician keeps moving their hand 402 closer to the one or more sensor modules 102, the CC values gradually open up a filter effect. The result is a snare drum hit that grows brighter and sharper as their hand approaches the one or more sensor modules 102. A combination of binary note triggering and continuous effect modulation happening simultaneously.

In some embodiments, the one or more sensor modules 102 are configured not only to detect static proximity values (e.g., a fixed distance between the performer's hand 402 and the sensor) but also to generate continuous, real-time readings representing gradual movement of the performer's hand 402 across a range of positions relative to the sensor. For example, as the hand 402 moves progressively closer to the one or more sensor modules 102, the output may correspondingly change from 0% (far) to 100% (near or touching), thereby allowing fine-grained modulation of musical parameters. Touching the one or more sensor modules 102 itself may be interpreted as a maximum proximity value (e.g., 100%), providing additional expressiveness to the performer.

In further embodiments, the one or more sensor modules 102 are configured to detect types of hand gestures that extend beyond proximity alone. For example, three-dimensional gesture recognition may include movement in a Z-axis (vertical) in combination with lateral X-Y movements, thereby enabling classification of gestures such as waving, drawing shapes, or forming symbolic hand signs (e.g., thumbs up). Such gesture detection expands the expressive vocabulary available to the performer by allowing complex input patterns, while velocity information associated with these gestures may further refine the responsiveness of the musical control system.

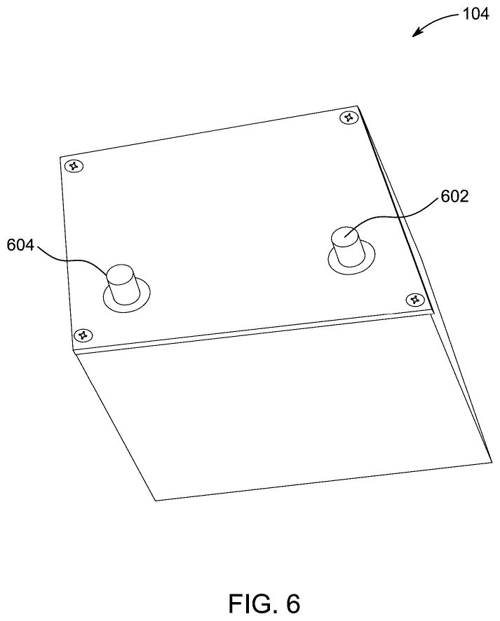

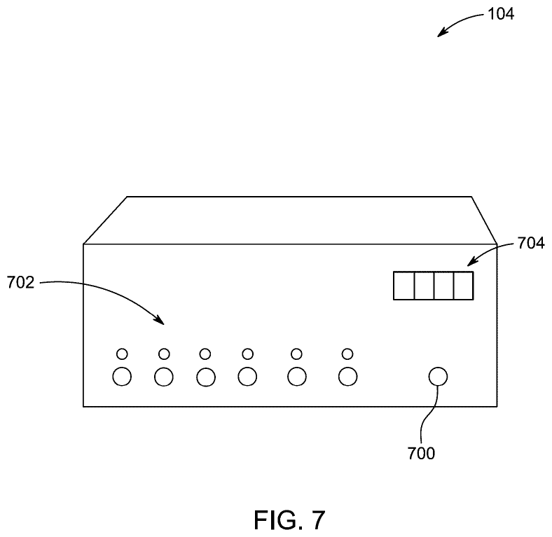

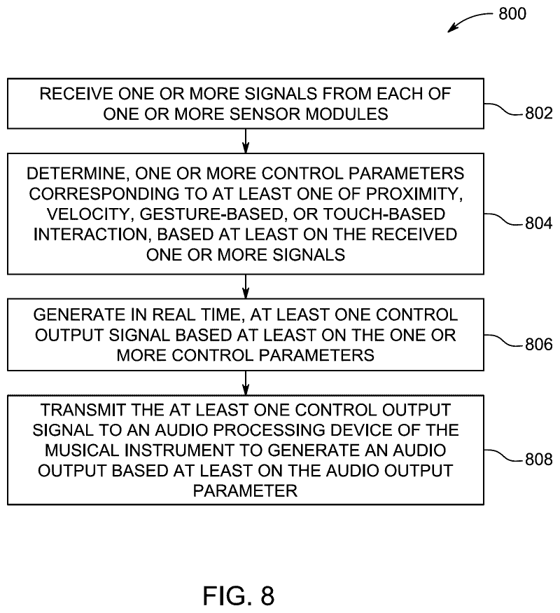

FIG. 6 illustrates a perspective view of the control hub 104, according to an embodiment of the present invention. FIG. 7 illustrates a front view of the control hub 104, according to an embodiment of the present invention.

As shown, the control hub 104 is depicted in the form of a foot-operated unit, although in alternative embodiments the control hub 104 may correspond to a musical instrument mounted hub. The control hub 104 is configured to establish bidirectional communication with each of the one or more sensor modules 102 detachably attached over the musical instrument 202, as described in FIGS. 2-5. In some embodiments, the control hub 104 further comprises one or more user-operable interfaces, including foot-operated switches. The switches may be configured to selectively enable or disable each of the one or more sensor modules 102 during operation. For example, actuation of a first switch 602 may enable a corresponding sensor module attached over the musical instrument 202, thereby allowing the sensor module to detect hand gestures and transmit the corresponding signals to the control hub. Conversely, actuation of a second switch 604 may disable the corresponding sensor module, thereby preventing the generation of signals from that module.

In certain embodiments, the control hub 104 further comprises additional buttons, dials, or rotary knobs 700 (shown in FIG. 7), which are configured to allow the user to change one or more system settings. For instance, a dial may be used to assign MIDI control numbers, to adjust the sensitivity of the proximity sensor modules, or to configure whether a sensor module operates in a Control Change (CC) mode, a Note On/Off mode, or a combined mode. By integrating such interfaces into the control hub 104, the system allows the performer to make real-time adjustments during a performance without requiring external computing devices.

In some embodiments, as described in FIG. 6 specifically demonstrates the advantage of a foot-operated control hub 104. In a live performance scenario, a musician playing the guitar may use their feet to press the switches 602, thereby enabling or disabling one or more sensor modules without interrupting their playing technique. This direct interaction ensures uninterrupted performance while simultaneously providing dynamic control over musical effects, sounds, and parameters. In alternative embodiments, the same control hub 104 may be mounted directly on the body of the musical instrument 202, in which case the musician may operate the additional buttons, dials, and switches by hand rather than by foot. Further, a switch corresponds to a master control element, which may be configured to globally enable or disable all connected the one or more sensor modules 102 or to toggle between different system modes. For example, in one mode, the control hub 104 may transmit raw gesture data to a connected computing device, while in another mode it may directly translate sensor data into MIDI Control Change (CC) messages.

In some embodiments, each of the one or more sensor modules 102 further comprises one or more light indicators. The light indicators are configured to provide a direct visual status of the operational state of the corresponding sensor module. When the switches 602 of the control hub 104 is actuated to selectively enable a sensor module, the corresponding light indicator is configured to turn into a particular color, thereby signifying that the sensor module is active and available for interaction. Conversely, when the switches 602 is actuated to selectively disable the sensor module, the light indicator is configured to change into another color, thereby signifying that the sensor module is inactive and not contributing to signal generation.

For example, in a modular musical control system 100 having three sensor modules detachably attached over a guitar, each of the sensor modules may include a light indicator in the form of a light-emitting diode (LED). When the sensor module-1 106 is enabled by the control hub 104 through the switches 602, the light indicator of the sensor module-1 106 is configured to turn into a green color. When the sensor module-1 106 is disabled by the switches 602, its light indicator is configured to turn into a red color. In this way, a performer on stage is able to immediately discern which of the one or more sensor modules 102 are actively transmitting signals to the control hub and which sensor modules are inactive, without requiring any additional display device.

The use of one or more colors for the light indicators further allows the performer to manage multiple sensor modules in real time. For instance, in a configuration where the light indicator turns blue when a sensor module is active in a Control Change (CC) mode, and yellow when the sensor module is active in a Note On/Note Off mode, the performer is provided with an intuitive visual feedback mechanism directly on the musical instrument. This facilitates dynamic switching between different performance modes, even under low-light conditions typically present in a stage environment.

Accordingly, the one or more light indicators configured to turn into one or more colors provide not only a functional confirmation of enablement or disablement of the sensor module, but also enhance usability and performance reliability. The musician is therefore able to selectively enable or disable specific sensor modules, and immediately verify the operational state of each module through the one or more colors displayed, thereby ensuring accurate and uninterrupted control of musical output during performance.

In one embodiment, the control hub 104 further comprises a plurality of light indicators 702, wherein each of the light indicators corresponds to a different mode of sensor control. For example, the control hub may include six distinct light indicators, each configured to emit a different color to represent one of six selectable modes. The user may toggle between these modes using additional buttons and switches 704 provided on the control hub 104 or on the sensor module. Each mode corresponds to a different operational configuration of the one or more sensor modules, such as controlling modulation, triggering notes, applying pitch bend, or engaging other MIDI-based functions.

In practice, when the user engages a particular switch on the control hub 104, a corresponding light indicator illuminates in a unique color, providing immediate visual feedback that the system is operating in the selected mode. For instance, a red indicator may correspond to a pitch bend mode, a blue indicator may correspond to note triggering mode, while a green indicator may correspond to modulation mode. This visual mapping ensures that the performer can quickly identify the active mode during a live performance, without needing to consult a separate display or software interface. The plurality of light indicators 702 thereby provide intuitive navigation between multiple performance configurations stored in the processor's memory.

In some embodiments, the initialization of the system 100 occurs in a default state in which the at least one processor 118 loads Bank 1 with baseline parameter values. For example, when the control hub 104 is powered on, the system 100 initializes to Bank 1, where CC values are set to zero, and both Note1 and Note2 are also set to zero. From this initialized state, subsequent presets or banks may be selectively activated by the performer through one or more switches of the control hub, thereby ensuring predictable startup behavior for the shoe sorter system.

In another example, explicit assignments of sensor outputs to MIDI messages are programmed within each preset. For instance, Preset 1 may be configured such that Message 1 corresponds to CC #1, Message 2 corresponds to Note1 #36 (C1), and Message 3 corresponds to Note2 #37 (C #1). Preset 2, by comparison, may be configured such that Message 1 corresponds to CC #2, Message 2 corresponds to Note1 #38 (D1), and Message 3 corresponds to Note2 #39 (D #1). In this manner, each preset may uniquely map sensor inputs to discrete MIDI parameters, enabling granular control of different musical or processing contexts.

In yet another implementation, chromatic mode may be enabled, wherein the at least one processor 118 is configured to generate a sequence of notes based on incremental sensor ranges. As the user moves their hand 402 through successive zones of the sensor range, the at least one processor 118 may output consecutive note messages in ascending or descending order, analogous to traversing a series of piano keys. This chromatic mapping permits real-time performance of melodic or harmonic sequences directly through hand gestures, without requiring traditional key or string interfaces.

In some variations, modulation values derived from the one or more sensor modules 102 may be further refined by scaling functions applied in the processor. The scaling functions may include linear curves, logarithmic curves, or exponential curves, each defining a distinct relationship between sensor proximity and corresponding MIDI value. For example, in a logarithmic curve, smaller hand movements near the sensor produce fine-grained control over low-range values, while larger movements further away result in rapid value changes. Such scaling options allow performers to tailor sensor responsiveness to their preferred playing dynamics.

In another example, the system 100 may be further configured to generate extended MIDI message types, including Aftertouch and MIDI Polyphonic Expression (MPE). By supporting Aftertouch, the processor enables continuous expressive control beyond the initial triggering of a note, whereas MPE enables simultaneous independent control of pitch, timbre, and expression across multiple dimensions for each note. These capabilities expand the expressive range of the system, allowing the performer to emulate acoustic instrument nuances or advanced sound design techniques.

Finally, the system 100 may incorporate a preset storage and erasure functionality within the control hub 104. A performer may save a preset by pressing and holding a designated switch, at which point the processor records the current configuration of messages, mappings, and sensor ranges into non-volatile memory. Similarly, a preset may be erased or reset by a corresponding long-press action on another designated switch. Such storage functionality ensures that complex mappings and performance modes may be reliably recalled in future sessions without requiring reprogramming.

Referring to FIG. 8 illustrates a flow chart of a method 800 associated with the modular musical control system 100, according to an embodiment of the present invention.

At operation 802, the at least one processor 118 which is communicatively coupled to a memory 120 of the control hub 104, receives one or more signals from each of the one or more sensor modules detachably attached over a musical instrument. The at least one processor 118 is communicatively coupled with the memory 120 that stores computer readable instructions. When the at least one processor 118 runs those instructions, connects with the one or more sensor modules that are attached to the musical instrument and send one or more signals to the processor.

At operation 804, the at least one processor 118 determines one or more control parameters corresponding to at least one of proximity, velocity, gesture-based, or touch-based interaction, based at least on the received one or more signals. The at least one processor 118 takes the one or more signals coming from the one or more sensor modules 102 and translates them into useful control parameters that describe how you're interacting with the instrument. These parameters may be based on proximity (how near or far the user's hand 402 is), velocity (how quickly the user's hand 402 move), gesture-based interaction (specific motions like swiping, waving, or holding still), or touch-based interaction (when the user actually touch the surface). In short, the processor is figuring out what kind of action the user just made so the at least one processor 118 may turn that movement into meaningful musical control.

At operation 806, the at least one processor 118 generates, in real time, at least one control output signal comprising at least one of analog or digital musical data, based at least on the one or more control parameters. The at least processor 118 takes the control parameters already figured out (like proximity, velocity, gesture, or touch) and instantly turns them into an output signal which may be analog musical data (like old-school continuous voltage signals used in synths) or digital musical data (like MIDI messages). Since it happens in real time, there's no delay and as soon as the user move the hand 402 or touch the one or more sensor modules 102, the at least processor 118 immediately generates the corresponding musical data, ready to control sounds, effects, or instruments.

At operation 808, the at least one processor 118 transmits the at least one control output signal to the audio processing device to generate an audio output based at least on the audio output parameter. Here the audio processing device corresponds to the control hub 104. The at least one processor 118 sends the control output signal just created over to an audio processing device such as a synthesizer, effects unit, or music software, which takes the signal and uses it as the audio parameter, which basically indicates how to shape the sound (for example: what note to play, how loud it should be, or how much an effect should change). In simple terms, the user's hand 402 movement gets converted into one or more signal by the at least one processor 118, and that signal is then transmitted to the audio gear so the at least processor 118 may turn the gesture into actual sound you can hear.

In some embodiments, the method or methods described above may be executed or carried out by a computing system including a tangible computer-readable storage medium, also described herein as a memory 120, that holds machine-readable instructions executable by a logic machine (i.e., at least one processor 118 or programmable control device) to provide, implement, perform, and/or enact the above-described methods, processes and/or tasks. When such methods and processes are implemented, the state of the storage machine may be changed to hold different data. For example, the storage machine may include memory 120 devices such as various hard disk drives, CD, flash drives, cloud storage, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include at least one of a wired or wireless communication devices to facilitate networked communication. The described methods or processes may be executed, provided, or implemented for a user or one or more computing devices via a computer-program product such as via an application programming interface (API).

As discussed earlier, the one or more sensor modules 102 detachably attached to the musical instrument 202, may be configured to detect the one or more hand gesture within the sensing region 500. Further, the one or more sensor modules 102 may further be configured to generate one or more signals indicative of the detected one or more hand gestures. The one or more sensor modules 102 may detect how close or far the user's hand 402 is from the one or more sensor modules 102. When the user moves the hand 402 near the one or more sensor modules 102, the one or more sensor modules 102 generates the one or more signal representative of numbers. The closer the user's hand 402 is, the bigger the number; the farther away, the smaller the number. In an example embodiment, the number may range from 1 to 127. As soon as the user's hand 402 enters in a sensing region of the one or more sensor modules 102, the at least one processor 118, decodes it as 1, while the proper touch of the user's hand 402 on the one or more sensor modules 102, may be decoded as 127. In this setup, the one or more sensor modules 102 may work up to about four inches away, but there are other sensors out there that may reach much further distances if needed.

Once the one or more sensor modules 102 detects the user's hand 402, the at least one processor 118 receives the sensor readings and rescales them into the standard range of 0 to 127 which is being used in MIDI, which is the universal language that electronic instruments and software use to communicate to each other. Further, the process begins with converting raw “hand movement” numbers into “music language” numbers. So, when the user's hand 402 is just barely in range, the at least one processor 118 sets the value to 1, and when the user's hand 402 touches the one or more sensor modules 102, the at least one processor 118 maxes out at 127. In some embodiments, the MIDI messages is composed of at least three messages that comprises at least note, velocity, and channel.

In some embodiments, a first type of message the numbers may create is called Control Change (CC). These messages are super versatile and may be used for things that change gradually, like turning a knob. To control volume the user's hand 402 may be low, the sound is quiet (0), and when the user hand 402 is close to the one or more control modules 102, the sound is loud (127) or maybe the at least one processor 118 control a filter, or panning, or reverb. The user's hand's motion up and down over the one or more sensor modules 102 is just like twisting a dial in real time smooth, continuous, and totally responsive.

In some embodiments, a second type of MIDI message is Note On/Note Off, which correspond to flipping at least one switch than turning a knob. The second type of MIDI message is binary which is either something is playing (On) or it's not (Off). As soon as the user's hand 402 crosses into the one or more sensor modules 102 range, a Note On message may be sent. The note keeps playing as long as the user's hand 402 stays within range, and when the user move his/her hand 402 out, a Note Off message may be sent and this simple action may let the user trigger sounds, beats, or melodies just by waving the hand 402 over the sensor.

In continuation, the velocity is basically how hard or fast the user hit the musical instrument 202, which translates into loudness or intensity. Further, the velocity may be tied to how quickly the user moves the hand 402 across the one or more sensor modules 102. Further, a quick swipe may trigger a loud note (high velocity), while a slow, gentle movement may trigger a softer note (low velocity). In one embodiment, velocity is locked at full blast (127). In another embodiment, the velocity may be implemented with dynamic control. That way, the user's gestures don't just turn notes on and off but also affect how they sound.

In some embodiments, the at least one processor 118 may be programmed to function in different ways. For example, the at least one processor 118 may be set up so that one note plays as soon as the user hand 402 breaks the one or more sensor module's threshold, and another note plays if the user actually touches the one or more sensor modules 102. Further, beyond CC and Note On/Off, there are other types of MIDI messages that may be send. For example, pitch bend lets the user smoothly change the pitch of a note, like bending a guitar string 206, while after touch may add extra expression after a note is triggered. That means your hand 402 movement not only control sound but also may help keep multiple devices in perfect rhythm.

Further, the system 100 is also designed to handle analog signals. Before MIDI existed, the user uses CV/Gate (Control Voltage and Gate) to control synthesizers. The embodiment of the invention may include both digital MIDI outputs and the option for analog CV/Gate outputs. Even if the user mostly using digital gear now, including analog as a possibility future-proofs the device and makes the system 100 compatible with a whole range of instruments, both modern and vintage. Conclusively, this setup both the old-school and new-school music languages.

In some embodiments, the data is transmitted to at least one processor 118 through at least one of a wired or wireless interface. The at least one processor 118 then translates that into MIDI messages and sends them audio processing device the user want to control comprising a synthesizer, a drum machine, a guitar pedal, or even music software in real time. In an embodiment, the one or more sensor modules 102 may be configured to be active, and the one or more sensor modules 102 may be configured in any variation of the on/off and/or gradual functionality. In an embodiment, one or more sensor modules 102 may be active and/or configured in a plurality of alignments of binary, on/off, and/or gradual functionality.

In embodiments, the modular musical control system 100 may include the wireless communication interface 122 configured to enable bidirectional communication between the one or more sensor modules 102 and the control hub 104. The one or more sensor modules 102 may further correspond to a sensor tab. Instead of a fixed number of sensors permanently mounted to a single housing, the system may include one or more sensor modules 102, each may be configured to adhere to a variety of surfaces, such as a guitar, a keyboard surface, a drum pad, a microphone stand, or a desk and may be attached using one or more fasteners comprising at least one of an adhesive fastener, a magnetic fastener, or a mechanical fastener. The one or more sensor modules 102 may communicate via at least one from wired or wirelessly with at least one processor 118.

In some embodiments, the modular musical control system 100 may allow the user to customize both the number and the arrangement of the one or more sensor modules 102 in a performance environment. For example, the user may attach one sensor from one or more sensor modules 102 to the guitar for simple triggering, or may deploy ten, twenty, or even up to one hundred sensor modules 102 throughout the performance environment to create a fully immersive interactive MIDI environment. The at least one processor 118 may be programmed or MIDI-mapped to trigger specific sounds, effects, or sequences in a Digital Audio Workstation (DAW) or other music processing software. The at least one processor 118 may receive one or more signals from each sensor module of one or more sensor modules 102 and determine one or more control parameters corresponding to at least one of proximity, velocity, gesture-based, or touch-based interaction, based at least on the received one or more signals, generate, in real time, at least one control output signal comprising at least one of analog or digital musical data, based at least on the one or more control parameters and transmit the at least one control output signal to an audio processing device to generate an audio output based at least on the audio output parameter.

In some embodiments, the placement of the one or more sensor modules 102 on the musical instrument, such as a guitar or any fixed surface, is configured to optimize ergonomic access and expressive control for the user. The one or more sensor modules 102 may be field-tested and arranged with millimeter-level specificity to align with natural hand 402 movements during performance. For example, a sensor module-1 106 may be positioned for activation by the lower thumb knuckle, and the sensor module-2 108 may be positioned to respond to the edge of the musician's palm. The one or more sensor modules 102 may be strategically offset from the guitar bridge to reduce the likelihood of accidental triggering while still allowing intentional activation during playing of the musical instrument.

In some embodiments, the physical placement of the one or more sensor modules 102 may be configured to integrate with conventional guitar-playing techniques. Movements such as hand 402 muting or string 206 damping may naturally engage the one or more sensor modules 102 without requiring a change in the user's performance posture. By aligning the activation regions with the user's habitual hand 402 paths, the system provides precise sensor engagement while maintaining a familiar tactile experience for the user.

In some embodiments, the at least one processor 118 may be integrated with guitar-specific performance techniques to enhance expressiveness without requiring the user to leave the musical instrument's natural playing position. The placement of the one or more sensor modules 102 and the pattern of modulation may align with the natural movements of the user's hand 402 along string of the guitar. For example, as the user performs palm muting, the hand 402 naturally moves into and out of the one or more sensor module's detection zone, producing a corresponding output that may mimic tonal variations or damping effects.

In some embodiments, the one or more sensor modules 102 may be configured to accommodate a range of hand sizes, dominant hand 402 orientations, and playing techniques. The physical arrangement of the one or more sensor modules 102 may be adapted for both left-handed and right-handed configurations. In some embodiments, the modular musical control system 100 may also support advanced guitar techniques such as Golpe-style tapping, to create percussive effects on the guitar body. In some embodiments, modular musical control system 100 may include shielding which may be configured to prevent the one or more sensor modules 102 which are close to the instrument pick-ups, from producing unwanted interference/noise.

In some embodiments, a base and the one or more sensor modules 102 may be configured in a variety of shapes and sizes to enhance both functionality and ergonomics. In one example, the base may be rectangular, similar to the pedal board, to allow the user to step on controls or arrange the system on the floor. In an example, the base may be triangular, oval, or rounded to improve hand 402 or finger access for gesture-based interaction, or to better fit within a user's studio or live performance setup. The one or more sensor modules 102 may be produced in different form factors, including flat rectangular tiles, curved pads, or small puck-shaped units, to facilitate specific mounting surfaces and to improve ergonomics during live play.

In some embodiments, the one or more sensor modules 102 may be incorporated in and/or onto and/or within a body, neck, bridge, pickguard, and/or headstock of the guitar. An alternate embodiment of the present invention, include a portable integrated musical instrument system. The system may include a trigger sensor. The modular musical control system 100 may also include a gradual effect sensor. The modular musical control system 100 may include a sound up sensor. The modular musical control system 100 may also include sound up sensor or button and sound down sensor or button. The modular musical control system 100 may include bank up sensor or button and bank down sensor or button. The modular musical control system 100 may also include a numeric display. The numeric display may be configured to display sound and/or bank level. The modular musical control system 100 may include input/output connection and input/output connection.

In some embodiments, the modular musical control system 100 may include a USB port. The USB port may connect to a computer, not shown. The USB port may also provide power to the system. The modular musical control system 100 may also include a stand-by switch configured to deactivate the one or more sensor modules 102. The one or more sensor modules 102 may include at least one of proximity sensor, the trigger sensor, the gradual effect sensor, the sound up sensor, the sound down sensor, the bank up sensor, or the bank down sensor. The system may additionally include a switch on a side of the system which may deactivate the sound up sensor.

Another alternate embodiment of the present invention may include a musical instrument system housed in a compact rectangular shaped box like enclosure which may utilize motion sensing technology to digitally control audio. The enclosure may include a flat topside surface, a right-hand side surface, and a front side surface. A graphic display may be positionable centrally on the topside surface and occupy about ⅛ to about ⅓ of the topside surface. A left-hand side proximity sensor positionable on an upper top and towards a left-hand side edge of an area of the topside surface. A right-hand side proximity sensor positionable on an upper top and towards a right-hand side edge of an area of the topside surface. Both right hand side proximity sensor and the left-hand side proximity sensor are configured on the topside surface to allow the user to interact with the sensors, and, with the user's left and/or right hands without impeding the user's view of the graphic display while playing the musical instrument system.

Further, light and displays may be positionable on a lower left-hand side of the topside surface. Further, control voltage (CV) ports may be positionable on left- and right-hand sides of the front surface. The system may also include GATE ports positionable on left- and right-hand sides of the front surface. Positioning of the sensors and one or more components of the system may allow the user to play the musical instrument and to not allow the placement of the logistical components of the system to interfere with the user's access to sensors, and other controls and to prevent obstruction of the musician's view of the graphic display. In embodiments, the CV and GATE ports and may include 3.5 mm ports.

Further, modular musical instrument system may also include interconnection points and other system controls on a back side surface and a left-hand side surface of the enclosure. A USB port may be located on a left-hand side surface of the enclosure. Also, a MIDI output port and a MIDI input port may be located on a left-hand side surface of the enclosure. In embodiments, the MIDI ports, and may include 3.5 mm ports.

Various controls may be located on the back side surface of the enclosure and designed to be controlled by the user's right- and left-hand thumbs. A switch or a plurality of switches or buttons may be located on a left-hand side of the back side surface of the enclosure. The system may include 2 push buttons to navigate banks located on a back side surface of the enclosure. On a right-hand side of the back side surface of the enclosure, a rotary thumbwheel may be positioned. In embodiments, the rotary thumbwheel may also include push button controls.

Positionable centrally on the bottom side may be a damping pad. The dampening pad may be configured to allow the enclosure to rest upon a flat surface while the musician plays the musical instrument.

In some embodiments, the system may include modular, wireless sensor tabs that extend the interactive area beyond the primary enclosure. Each tab may include one or more proximity, pressure, or velocity sensors encapsulated in a small, durable housing with adhesive or clip mounts. The tabs may be temporarily affixed to instruments, stage surfaces, or pedal board 204s. Each tab may communicate wirelessly with the main system, transmitting gesture, threshold, and activation data for real-time mapping to sounds and effects.

In some embodiments, the system may include at least one processor 118 acting as the central aggregation point for the wireless tabs and main enclosure. The at least one processor 118 may include wireless transceivers, USB/MIDI ports, CV/Gate outputs, and an onboard processor. In some embodiments, the at least one processor 118 may be a standalone floor unit or tabletop device, while in other embodiments it is integrated within the main enclosure.

In embodiments, the system may include trigger sensors and on the face of the box and may function in the same way a simple binary button or a key would. When your hand 402 crosses the threshold of the sensor's field of detection, for example about 1, 2, 3, 5, 10, 20 cm above the sensor or any dimension in between, it's the same as if you were to push down on a button and holding down if your hand 402 remains in the field of detection. As soon as your hand 402 leaves the threshold, it's the same as if you were releasing the button. The system may also be programmed so that you may also touch the sensor to achieve the same functionality. The system feature helps for musical purposes because sometimes you want to tap a button repeatedly, very quickly, which is easier to do by actually tapping the surface of the box, as opposed to waving your hand 402 above it, which you may also do. The system may include a plurality of ways to actuate the system. The system may also include two ways of pushing this imaginary button, by waving your hand 402 in the air above the sensor, and by physically tapping the sensor.

In some embodiments, the “effect” sensor on the side of the box functions like a knob or a dial would. When unaffected, the knob is at 0%, as soon as your hand 402 crosses the threshold of detection and moves closer and closer to the sensor, it gradually goes up to 100% and remains at 100% if your hand 402 is touching the sensor. This may manipulate effects that a musician may want to turn up or down in real time, such as volume, panning, distortion, reverb, delay, or any effect in a DAW or other software/hardware. Interaction with a DAW allows you to customize the range of each sensor, for example, from 0% to 50% In addition, the range of each sensor may be adjusted in the program module, depending upon user settings.

In some embodiments, the “effect” sensor on the side of the box functions like a knob or a dial would. When unaffected, the knob is at 0%, as soon as your hand 402 crosses the threshold of detection and moves closer and closer to the sensor, it gradually goes up to 100% and remains at 100% if the hand 402 is touching the sensor. This is useful for sound effects that you want to turn up and down volume, panning, distortion, reverb, delay, etc. basically any effect imaginable that is supported by your DAW. Any gradual effect or parameter is customizable in your DAW. If you only want a certain effect to go up to a maximum value of 50%, you may set that as your max value in your DAW, so when the sensor is at its maximum value of 100% the parameter will only go up to 50%. Interaction with DAW allows you to customize the range of each sensor. In addition, the range of each sensor may be tweaked in the program module, depending upon how it is coded.

In some embodiments, the sensors in the modular musical control system 100 may include an array of sensors. The system may include algorithms and programming to program all three sensors to function both as a binary button and a gradual dial, to further customize the user experience. In the system, crossing the threshold of detection may register as “on” but also as gradually going from 0% to 100%. Furthermore, both a sound and an effect may be MIDI-mapped to the same sensor: once the threshold is crossed, the sound will play and the effect will increase 0% to 100%. In some embodiments, the sensors may include a plurality of functions.

In some embodiments, the sensors on the modular musical control system 100 may include an array of sensors. The modular musical control system 100 may include algorithms and programming to program all three sensors to function both as a binary button and a gradual dial, to further customize the user experience. In the system, crossing the threshold of detection may register as “on” but also as gradually going from 0% to 100%. So if you want to MIDI map just a sound to it, that's fine, it'll just be registered as “on” or “off” to play the sound, but if you want to MIDI map an effect to it, that's good too, it'll turn up the dial on the effect, nothing may trip anything up, it's how you configure things in your DAW that may determine how the sensor reacts, because it's essentially reacting in both ways at the same time). Furthermore, if you want to MIDI map both a sound and an effect to the same sensor, you may do that too: once the threshold is crossed, the sound will play and the effect will start ticking up from 0% to 100%. In some embodiments, the sensors may include a plurality of functions. The two trigger sensors may act only as buttons, and the one effects sensor may act only as a dial, and therefore all sensors may be able to act as both buttons and dials.

In some embodiments, the modular musical control system 100 may include materials such as but not limited to stainless steel, other metals, ceramic, plastic, composites, and/or wood. In some embodiments, the modular musical control system 100 may integrate auxiliary modules such as wireless foot pedals, mini-pods, or clip-on controllers. The auxiliary modules may provide bank navigation, additional triggers, or continuous control signals. The auxiliary modules may operate wirelessly or via cable, and may function independently or in conjunction with the enclosure and the at least one sensor pod.

In some embodiments, the modular musical control system 100 may include materials such as but not limited to stainless steel, other metals, ceramic, plastic, composites, and/or wood. It's also very strong, it may be made of stainless steel and may take a beating, you may get physical with it, you may pick it up, play it, and because the sensors are so reactive it's almost like you're playing an old percussive instrument—most MIDI controllers aren't built for that sort of thing.

In some embodiments, the modular musical control system 100 may include a three-way switch. The three-way switch may be configured to reorganize the sensors in a plurality of arrangements.

In some embodiments, data transmitted by the one or more sensor modules 102 may gradually change as a distance between an object (i.e. a human hand) and the at least one sensor changes, wherein the data gets concurrently processed in real-time through a data processor, including but not limited to a microcontroller, within the system and is simultaneously converted into a series of customizable commands to play and manipulate sounds, effects and/or parameters in accordance with the object placement and the object motion and the object velocity. These commands may include binary commands, such as MIDI note on or MIDI note off messages, gradual commands, such as MIDI CC or Continuous Control/Control Change messages, velocity-based commands, such as MIDI Velocity messages, or any combination of the aforementioned commands.

In some embodiments, the MIDI controller may be housed within an enclosure, which may be constructed from durable materials such as stainless steel, aluminum, polycarbonate, or composite plastics to withstand physical handling and stage use. The enclosure may correspond to a rectangular enclosure. The enclosure may be portable and compact.

In embodiments, a top surface of the enclosure may include four fasteners. The four fasteners may include at least one of machine screws, threaded bolts, or rivets, positioned proximate to four corners of the top surface. The four fasteners may secure the top surface of the enclosure to a base housing, and may provide mechanical stability and internal component protection. In some embodiments, the four fasteners may be removable to allow service, battery replacement, or sensor module upgrades.

In embodiments, extending from the top surface of the enclosure are two protrusions, which in some embodiments may serve as wireless communication antennas. The protrusions may enable bidirectional wireless communication between the MIDI controller and at least one processor 118, as well as external devices such as a digital audio workstation (DAW), MIDI-enabled synthesizer, or other wireless receivers. The protrusions may operate via Bluetooth Low Energy (BLE), Wi-Fi, proprietary 2.4 GHz, or other low-latency wireless protocols.

An embodiment of the present invention may include a circular detachable sensor module. The circular detachable sensor module may be configured to magnetically receive and retain the detachable sensor pods in one or more positions on a surface. The circular detachable sensor module may further include charging contacts or inductive charging circuitry such that the detachable sensor pods may automatically charge when magnetically attached. The relative positions of the detachable sensor pods on the circular detachable sensor module may additionally be detected and used to modify or generate musical outputs, including triggering notes, modulating effects, or controlling MIDI parameters.

In some embodiments, each detachable sensor pod may include at least one of a touch sensor, motion sensor, rotation sensor, or proximity sensor, allowing the system to capture one or more human gestures or interactions. The detachable sensor pods may be biased to perform one or more functions, such as note triggering, pitch modulation, effect control, or keyboard emulation, or alternatively may all be configured identically. In some embodiments, the circular detachable sensor module may support scalability, and may allow an arbitrary number of the detachable sensor pods to be attached and charged simultaneously.

In some embodiments, the system may incorporate environmental and multi-modal sensing, including RGB color, barometric pressure, vibration, temperature, and humidity sensors. For example, waving a colored object may change timbre or scale, or stage vibrations may trigger percussive effects. Environmental inputs may modulate DAW parameters dynamically.

In some embodiments, the system may provide visual or holographic feedback, projecting indicators above the enclosure to visualize active zones, velocity, and modulation depth. Holographic cues may guide the user in 3D space, turning the air above the system into an expressive, touchless interface.

The modular musical control system may comprise at least one sensor pod coupled to the musical instrument. The at least one sensor pod may be configured to generate sensor data. The at least one sensor pod may comprise proximity sensors selected from a group consisting of short-range proximity sensors, long-range proximity sensors, optical proximity sensors, and infrared proximity sensors. The proximity sensors may include a plurality of emitters, receivers, infrared LEDs, or photodiodes configured to detect movement of a hand 402, finger, or palm. In embodiments, the proximity sensors may be positioned near a bridge portion of the musical instrument to allow selective triggering by a lower knuckle or palm area of the user's hand 402 during the performance. In embodiments, the at least one sensor pod may be repositionable to one or more locations on the musical instrument to enable customized placement for a plurality of playing techniques or musical styles.

While the foregoing written description of the exemplary embodiments enables one of ordinary skill to make and use what is considered presently to be the best mode thereof, those of ordinary skill will understand and appreciate the existence of variations, combinations, and equivalents of the specific embodiment, method, and examples herein. The exemplary embodiments should therefore not be limited by the above-described embodiment, method and examples, but all embodiments and methods within the scope and spirit of the exemplary embodiments as claimed.

Since many modifications, variations, and changes in detail may be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In so far as the description above and the accompanying drawings disclose any additional subject matter that is not within the scope of the claims below, the inventions are not dedicated to the public and the right to file one or more applications to claim such additional inventions is reserved.

What is claimed is:

1. A modular musical control system comprising:
one or more sensor modules detachably attached over a musical instrument, wherein each of the one or more sensor modules are configured to:
detect one or more hand gestures of a user within a sensing region; and
generate one or more signals indicative of the detected one or more hand gestures;
a control hub communicatively coupled to each of the one or more sensor modules, wherein the control hub comprising:
a memory having one or more computer readable instructions;
at least one processor communicatively coupled to the memory, wherein the at least one processor executing the one or more computer readable instructions stored in the memory is configured to:
receive the one or more signals from each of the one or more sensor modules;
determine one or more control parameters corresponding to at least one of proximity, velocity, gesture-based, or touch-based interaction, based at least on the received one or more signals;
generate, in real time, at least one control output signal comprising at least one of analog or digital musical data, based at least on the one or more control parameters; and
transmit the at least one control output signal to an audio processing device to generate an audio output.

2. The modular musical control system of claim 1, wherein each of the one or more sensor modules comprises at least a short-range proximity sensor, a long-range proximity sensor, optical proximity sensors, and infrared proximity sensors.

3. The modular musical control system of claim 1, wherein each of the one or more sensor modules and the control hub further comprises at least one of a wired or wireless communication interface configured to enable bidirectional communication between the one or more sensor modules and the control hub.

4. The modular musical control system of claim 1, wherein the one or more control parameters comprise a value derived from received one or more signals indicative of at least one of a proximity between hand of the user and the one or more sensor modules, a velocity of the hand gestures relative to the one or more sensor module, or type of the hand gestures performed by the hand.

5. The modular musical control system of claim 1, wherein each of the one or more sensor modules are removably attached over the musical instrument using one or more fasteners comprising at least one of an adhesive fastener, a magnetic fastener, or a mechanical fastener.

6. The modular musical control system of claim 1, wherein the audio processing device corresponds to an audio processing device of the musical instrument, software instrument, device firmware, user interface, a digital audio workstation (DAW), or a MIDI-enabled device to control the device's parameters and audio output during a performance, and wherein the analog or digital musical data comprises at least one of musical instrument digital interface (MIDI) data that is configured to control and modulate musical notes, sounds, effects, and parameters.

7. The modular musical control system of claim 1, wherein the control hub may correspond to a foot-operated control hub or musical instrument mounted control hub, wherein the control hub further comprises additional buttons, dials, and at least one switch configured to selectively enable or disable each of the one or more sensor modules or change system settings.

8. The modular musical control system of claim 7, wherein each of the one or more sensor modules further comprises one or more light indicators, wherein the one or more light indicators are configured to turn into one or more colors when the at least one switch is configured to selectively enable or disable corresponding sensor module of the one or more sensor modules.

9. The modular musical control system of claim 1, wherein each of the one or more sensor modules are configured to be repositionable to one or more locations over the musical instrument to enable customized placement for a plurality of playing techniques or musical styles.

10. The modular musical control system of claim 1, wherein each of the one or more sensor modules are configured to provide combined control modes, including gradual control based on proximity, velocity-sensitive control based on striking or swiping motions, binary triggering based on touch-based percussive interaction and the 3-dimensional gesture interaction.

11. A method comprising:
receiving, via at least one processor communicatively coupled to a memory of a control hub, wherein the at least one processor executing the one or more computer readable instructions stored in the memory of the control hub communicatively coupled to each of one or more sensor modules, one or more signals from each of the one or more sensor modules detachably attached over a musical instrument,
wherein each of the one or more sensor modules are configured to:
detect one or more hand gestures of a user within a sensing region; and
generate one or more signals indicative of the detected one or more hand gestures;
determining, via the at least one processor, one or more control parameters corresponding to at least one of proximity, velocity, gesture-based, or touch-based interaction, based at least on the received one or more signals;
generating, in real time, via the at least one processor, at least one control output signal comprising at least one of analog or digital musical data, based at least on the one or more control parameters; and
transmitting, via the at least one processor, the at least one control output signal to an audio processing device to generate an audio output.

12. The method of claim 11, wherein each of the one or more sensor modules comprises at least a short-range proximity sensor, a long-range proximity sensor, optical proximity sensors, and infrared proximity sensors.

13. The method of claim 11, wherein each of the one or more sensor modules and the control hub further comprises at least one of a wired or wireless communication interface configured to enable bidirectional communication between the one or more sensor modules and the control hub.

14. The method of claim 11, wherein the one or more control parameters comprise a value derived from received one or more signals indicative of at least one of a proximity between hand of the user and the one or more sensor modules, a velocity of the hand gestures relative to the one or more sensor module, or type of the hand gestures performed by the hand.

15. The method of claim 11, wherein each of the one or more sensor modules are removably attached over the musical instrument using one or more fasteners comprising at least one of an adhesive fastener, a magnetic fastener, or a mechanical fastener.

16. The method of claim 1, wherein the audio processing device corresponds to an audio processing device of the musical instrument, software instrument, device firmware, user interface, a digital audio workstation (DAW), or a MIDI-enabled device to control the device's parameters and audio output during a performance, and wherein the analog or digital musical data comprises at least one of musical instrument digital interface (MIDI) data that is configured to control and modulate musical notes, sounds, effects, and parameters.

17. The method of claim 11, wherein the control hub may correspond to a foot-operated control hub or musical instrument mounted control hub, wherein the control hub further comprises additional buttons, dials, and at least one switch configured to selectively enable or disable each of the one or more sensor modules or change system settings.

18. The method of claim 17, wherein each of the one or more sensor modules further comprises one or more light indicators, wherein the one or more light indicators are configured to turn into one or more colors when the at least one switch is configured to selectively enable or disable corresponding sensor module of the one or more sensor modules.

19. The method of claim 11, wherein each of the one or more sensor modules are configured to be repositionable to one or more locations over the musical instrument to enable customized placement for a plurality of playing techniques or musical styles.

20. The method of claim 11, wherein each of the one or more sensor modules are configured to provide combined control modes, including gradual control based on proximity, velocity-sensitive control based on striking or swiping motions, binary triggering based on touch-based percussive interaction and the 3-dimensional gesture interaction.
